(19) United States
(12) Patent Application Publication
(10) Pub. No.: US 2004/0102935 A1
(43) Pub. Date: May 27, 2004

(54) Method for regulating a property of a product derived from a chemical transformation

(76) Inventors: Marc Lacroix, Louvain-la-Neuve (BE); Yves Hontoir, Wemmel (BE)

Correspondence Address: Finnegan Henderson Farabow, Garrett & Dunner, 1300 I Street NW, Washington, DC, 20005-3315, US

(21) Appl. No.: 10/276,799

(22) PCT Filed: Feb. 14, 2002
(86) PCT No.: PCT/EP02/01670

(30) Foreign Application Priority Data
Feb. 19, 2001 (FR) 01/02301

(51) Int. Cl. G06F 17/10

(52) U.S. Cl. 703/2

(57) ABSTRACT

The invention concerns a method for regulating a property of a product derived from a chemical transformation process, consisting in: a) modelling the relationship between said property and characteristic physical quantities of the process; b) fixing a set point value for said property; c) introducing said set point value in a regulation system based on the model obtained in (a) so a to apply to the process at least a physical quantity calculated from said set point value; d) calculating with a model defined in (a), corrected by a factor taking into account the delay, of a model value of the property of the product corresponding to the characteristic physical quantity/quantities defined by the regulation system; e) continuously measuring the real value of the property and the model value of the property of the product; f) determining the difference between said real value and the model value of the property of the product; g) using said difference, after filtering, to adapt the set point value so as to align the real value and its model value. The invention also concerns a regulating device and a chemical transformation method using said device for implementing said method.

The present invention relates to a method of regulating a property of a product resulting from a chemical transformation process and to a regulating device, as well as to a chemical transformation process using such a method or such a regulating device.

The industrial application of any chemical transformation process, such as for example a synthesis, polymerization, degradation or depolymerization process, requires, on the one hand, that relatively strict technical specifications for the product be met and, on the other hand, that the incoming material be used economically and efficiently. The inevitable automation that results therefrom therefore requires suitable, but flexible, control or regulating methods that allow the chemical processes to be optimally controlled.

The mathematical modeling attempts that are based on these methods are as numerous as the chemical processes to be controlled. The models conventionally employed are those of the PID type (that is to say those comprising a proportional term, an integral term and a differential term) for individually controlling a relatively large number of parameters (for example temperature, pressure, flow rates, etc.). However, this type of model is not easily applicable to a large number of chemical transformation processes, since these are often blemished by lengthy downtimes or delays, either in the process itself or in the measurements needed for feeding into the model. These consequently result in substantial amounts of scrap that does not comply with the specifications set, for example due to the phenomenon of oscillation caused by the parameters in the model being corrected too late and therefore often too much.

The prediction techniques developed for responding to the limitations of the conventional methods has not been able successfully to supplant these methods which are simple to employ.

It would therefore be desirable to have an entirely automatable regulating method which is simpler and better suited to chemical transformation processes.

The present invention consequently provides a method of regulating a property of a product resulting from a chemical transformation process, consisting:

a) in modeling the relationship between said property and characteristic quantities of the process;

b) in setting a setpoint value for said property;

c) in introducing this setpoint value into a regulating system based on the model obtained in (a) so as to apply at least one characteristic quantity, computed from this setpoint value, to the process;

d) in computing, by means of the model defined in (a), corrected by a factor that takes the delay into account, of a model value of the product property corresponding to the characteristic quantity/quantities defined by the regulating system;

e) in continuously measuring the actual value of the product property;

f) in determining the difference between this actual value and the model value of the product property; and

g) in using this difference, after filtering, to adapt the setpoint value so as to align the actual value and its model value.

According to a preferred variant, the regulating method according to the invention includes the computing (d) of the model value of the property corresponding to the characteristic quantity/quantities using the model obtained in (a), corrected by the factor that takes the delay into account and by a factor that takes the dynamics of the process into account.

Such a method, which comprises only a single regulating loop and which does not involve direct comparison between the setpoint value and the actual value of the property, consequently has an advantage in terms of simplicity over the conventional techniques which comprise a regulation based on the comparison of the actual value with the setpoint value on which is superposed a regulation involving, separately, a model for the process and a model for the delay. Moreover, the use of defined mathematical models for computing the model values makes it possible to computerize, and consequently completely automate, the process without the need for any human intervention with regard to compensating for the errors due to the delay or for other external perturbations.

This method may be employed for any chemical transformation process, such as a synthesis process, a polyaddition process, a polymerization process, a grafting process, a degradation process, etc. However, it should be understood that the envisioned process may also include other treatment steps, whether they be of a chemical nature and/or of a physical nature, which are needed for obtaining the desired end product. As an example, mention may be made of homogenization, mixing, washing, drying, granulation, molding, etc.

The relevant product property (or properties) to be monitored and to be regulated obviously depends (or depend) both on the process employed and on the objective pursued. As a nonexhaustive illustration, mention may be made of the chemical characteristics, such as the nature or the composition of the resulting product, but above all of the physical characteristics, such as the molecular weight or the molecular weight distribution, the melting point, the stiffness, the viscosity, the melt flow index (MFI), the melt swell, the bubble stability, etc.

One particular embodiment of the present invention provides for such a regulating method to be applied to a process for transforming a polymer in an extruder. For example, this may be a polymer crosslinking process in which crosslinking agents chosen, for example, from peroxide compounds and diazo compounds are used. It is preferably a depolymerization process using, as reactants, one or more polymers and one or more depolymerization agents.

The objective of this depolymerization may, for example, be to adjust the Theological properties of the end product, said depolymerization very often including other steps (called post-treatment steps), for example granulation of the product output by the extruder.

The polymers envisioned include olefin polymers and copolymers containing two to eight carbon atoms, for example ethylene, propylene, etc. Typical polyolefins are ethylene and propylene polymers and copolymers, such as for example a polypropylene (PP) homopolymer and copolymers of propylene with secondary amounts of other olefins.

The nature of the depolymerization agents is not critical provided that they are suitable for this purpose. Examples are oxygen, oxygen-rich compounds, such as peroxides, persulfates and diazo compounds. Preferred depolymerization agents include diaryl, dialkyl and arylalkyl peroxides. 2,5-dimethyl-2,5-di(tert-butylperoxy)hexane is very suitable. It is also possible to use several depolymerization agents separately or as a mixture.

The “reactants”, as used within the context of the present invention, also includes other substances which are necessary for the envisioned process to be carried out correctly, but which are not directly involved in the reaction or reactions proper. These may be any useful additives or adjuvants, such as stabilizers, antioxidants, antistatic agents, organic dyes, mineral pigments and fillers, etc., it being possible for these additives and adjuvants to be added at any appropriate moment. Thus, the addition may take place simultaneously, in mixing, successively or even at different steps of the process, depending on the nature and the function of the additive or adjuvant in question.

Another aspect of the present invention envisions measuring the actual value of the product property on a specimen of the end product and not on an intermediate product, as the prior art dictates, in order to reduce the effect of the delay. This is because, as we mentioned above, the great majority of chemical transformation processes used in industry involve several chemical and/or physical steps before the intended product is obtained. The properties of this product are consequently liable to change over the duration of the process.

This variant of the present invention thus has the further advantage of also integrating, into the regulation, other perturbations that are associated with the post-treatment of the product.

The technical instrumentation used to analyze the product and to determine the actual value of the product property obviously depends on the latter, but is not critical. The choice will furthermore depend on the simplicity of implementation, the reliability, the rapidity or the availability. For example, for determining the melt flow index (MFI), rheometric techniques, spectroscopic methods (IR, NIR, NMR) and ultrasonic analyses are suitable, but not exclusive.

The actual value of the property is used to determine the difference between this actual value and the model value, that is to say the value computed by means of the mathematical model and corrected by the delay factor and optionally the dynamic factor. This difference is then employed to adapt the setpoint value so as to align the actual value and the model value. In a preferred aspect of the present invention, this difference is, however, firstly subjected to a filtering step for the purpose of moderating the aggressiveness of the regulator, for example by introducing an appropriate filter, such as a filter of the low-pass type with an adjustable time constant, in the control loop.

The mathematical model involved in the method of the present invention may be based on an equation of the type:

$$\begin{matrix}MV = a + bIV + {\sum }_{i = 1}^{n} {\sum }_{j = 1}^{p} {{c}_{ij} [ {R}_{j} ]}^{i} + {\sum }_{i = 1}^{n} {\sum }_{j = 1}^{p} {{d}_{ij} [ Tj ]}^{i} + \\ {\sum }_{i = 1}^{n} {\sum }_{j = 1}^{p} {{e}_{ij} [ {P}_{j} ]}^{i} + {\sum }_{i = 1}^{n} {\sum }_{j = 1}^{p} {{f}_{ij} [ Fj ]}^{i}\end{matrix}$$

where:

MV represents the model value or estimated value;

IV represents the initial value of the property;

[Rⱼ] represents the concentrations of the reactants;

[Tⱼ] represents characteristic temperatures of the process;

[Pⱼ] represents characteristic pressures of the process;

[Fⱼ] represents the flow rates of the reactants;

a, b, cᵢⱼ, dᵢⱼ, eᵢⱼ and fᵢⱼ are constants;

i and j are natural integers greater than or equal to 1.

Another embodiment of the present invention is a regulating method in which the model is based on an equation of the type:

$$\begin{matrix}log MV = {a}^{′} + {b}^{′} log IV + {\sum }_{i = 1}^{n} {\sum }_{j = 1}^{p} {{c}_{ij}^{′} [ {R}_{j} ]}^{i} + {\sum }_{i = 1}^{n} {\sum }_{j = 1}^{p} {{d}_{ij}^{′} [ Tj ]}^{i} + \\ {\sum }_{i = 1}^{n} {\sum }_{j = 1}^{p} {{e}_{ij}^{′} [ {P}_{j} ]}^{i} + {\sum }_{i = 1}^{n} {\sum }_{j = 1}^{p} {{f}_{ij}^{′} [ Fj ]}^{i}\end{matrix}$$

where:

MV, IV, [Rⱼ], [Tⱼ], [Pⱼ], [Fⱼ], i and j have the meanings indicated above and a′, b′, c′ᵢⱼ, d′ᵢⱼ, e′ᵢⱼ and f′ᵢⱼ are constants.

The factor taking the delay into account may be represented by any suitable known method, for example the method of the “Smith predictor” as described, for example, in Chemical Engineering Progress, Vol. 53, No. 5, May 1957, pages 217-219. An advantageous embodiment for implementing the regulating method according to the invention provides for the factor taking the delay into account to be obtained by using a shift register. The factor taking the dynamics of the process into account is advantageously represented by an “LAG”-type function or a low-pass filter. One function of this particularly simple type giving good results is a function following the formalism of Laplace transforms satisfying the equation y(t)=1/(1+pTp) in which p represents the period of the measurement and Tp the time constant of the process. Such methods and functions are well known to those skilled in the art.

Furthermore, the present invention provides, according to another aspect, a device for regulating a property of a product resulting from a chemical transformation process, comprising:

at least one unit for regulating at least one characteristic quantity on the basis of a setpoint value of the property to be regulated;

at least one computing unit for determining a model value of the property to be regulated on the basis of the values of the characteristic quantity/quantities defined by the regulator;

means for continuously measuring the actual value of the product property;

means for determining the difference between the actual value and the model value of the property and for filtering this difference; and

means for adapting the setpoint value so as to reduce this difference,

The device according to the invention preferably uses a regulating method in accordance with the present invention in the manner described above.

Another embodiment provides a device in which the computing unit uses a model with proportional, integral and/or differential terms, corrected by a factor taking the delay into account and possibly by a factor taking the dynamics of the process into account.

In one embodiment, the regulating unit uses the inverse of the model generated for the computing unit.

The characteristic quantities of the chemical transformation process that can be controlled by the device of the invention are chosen, for example, from among the concentrations and flow rates of the reactants, the residence times, the pressures and/or temperatures of one or more of the steps of the process.

Moreover, the present invention envisions a chemical transformation process that uses a regulating device as described above, or employing a regulating method according to the invention, for monitoring and regulating a property of a product resulting from a chemical transformation process.

As indicated above, this chemical transformation may represent or comprise, for example, one or more synthesis, polyaddition, polymerization, grafting and/or degradation steps and, optionally, one or more physical procedures, such as homogenization, mixing, drying, granulation, molding, etc. The preferred process according to the invention is a depolymerization reaction using one or more polymers and one or more depolymerization agents as reactants.

The nature of the polymers was described above and is preferably a polyolefin, such as polypropylene.

The depolymerization agent/s is/are chosen especially from among oxygen, oxygen-rich compounds, peroxides, persulfates and diazo compounds, as described above.

As we have mentioned above, it is in principle possible to monitor any property of the end product. Thus, in one method of implementing the process according to the present invention, the product property to be monitored and regulated is the melt flow index (MFI) by acting on the abovementioned parameters. The melt flow index is determined, for example, continuously using a rheometer, an IR spectrometer, an NIR spectrometer, an NMR spectrometer and/or an ultrasonic analyzer, either directly in line or preferably on a specimen of the end product.

The in-line measurement involves the withdrawal of part of the product stream, for example in the case of an extrusion upstream of the dye in order to feed the chosen analyzer, for example a rheometer. However, apart from the drawback that such a measurement does not consider any variations associated with the post-treatment of the product, further disadvantages must be taken into consideration, especially a delay that is nevertheless long (compared with the time constant of the process), even in the case of in-line measurement, the proximity of sensitive measurement apparatuses and/or the resulting space requirement of the production plant.

Continuous determination on the end product is therefore preferred. It should be noted that what is meant by continuous measurement of the actual value of the product property is a measurement carried out at a regular rate by means of an automatic apparatus.

When the process according to the present invention is applied to the regulation of the MFI, the model value of the MFI may be computed on the basis of the model:

MFI_{OUT}=A+B. MFI_{IN}+c.[PER]+D.T

where:

MFIₒᵤₜ represents the estimated melt flow index of the depolymerization product;

MFIᵢₙ represents the melt flow index of the polymer reactant;

A, B, C and D represent constants;

[PER] represents the concentration of depolymerization agent in the material entering the process; and

T represents the temperature at which the depolymerization reaction takes place.

In other cases, the process applied to the regulation of the melt flow index (MFI) of a polymer, in which the model of the MFI satisfies a first-order equation in the concentration of depolymerization agent ([PER]) of the type:

logMFIₒᵤₜ=A′+B′.logMFIᵢₙ+C′.[PER]+D.T

or else a second-order equation

logMFI₀ₒᵤₜ=A″+B″.logMFIᵢₙ+C₁″.[PER]+C₂″.[PER]²+D″.T

where

MFIₒᵤₜ, MFIᵢₙ, [PER] and T have the meanings given above and A′, B′, C′, D′, A″, B″, C₁″, C₂″ and D″ represent constants.

The delay factor and the dynamic factor are those described above within the context of the present invention and may be defined by any methods known per se, such as more particularly those mentioned above.

In practice, although the models adopted above implicitly use the concentration of the depolymerization agent to regulate the melt flow index, it is also possible to acquire this property more simply by adjusting the feed flow rate of the depolymerization agent. In the latter case, it is assumed that volume variation due to variable amounts of depolymerization agent or, in other words, the dilution effect, is negligible.

In one practical method of implementation, the flow rate (concentration) of the depolymerization agent(s) is in turn regulated by a simple local feedback loop, for example of the PID type, so as to control the flow rate (the concentration) actually delivered by the metering devices.

The actual flow rate may be determined by any device suitable for this purpose, generally a flow meter, such as a Coriolis flow meter. Another very simple and often sufficient possibility is to infer the flow rate from the speed of rotation and from the stroke of the piston of the pump.

The model on the basis of the method of the present invention may in some cases be further simplified. Unless raw materials of sufficiently constant quality are used, it may be assumed, for example, that the polymer reactant melt flow index (MFIᵢₙ) is invariable.

The same applies to the temperature (T): if the process is carried out under essentially steady-state conditions, the equation is further simplified.

In practice, the model will then be reduced to a first-order linear model in a single variable. The factor that takes the delay into account may also be reduced to a pure delay and may be employed by any suitable method, for example by the “Smith predictor” approach or by using a shift register. In practice too, the factor taking the dynamics of the process into account is usually reduced to a first-order low-pass filter.

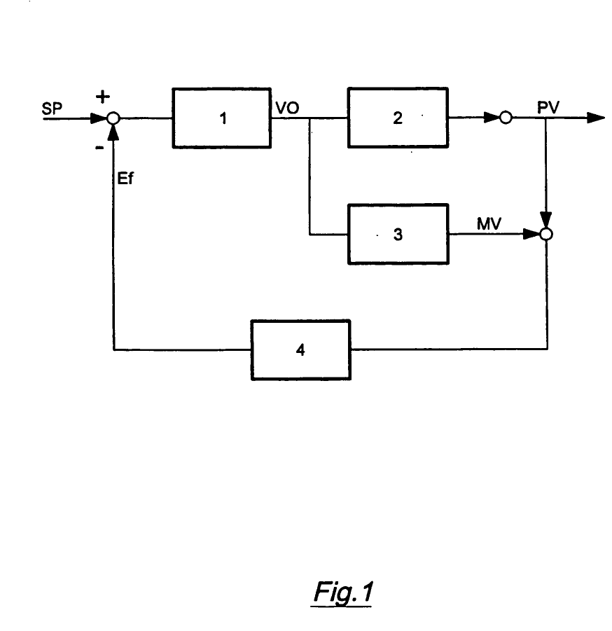

FIG. 1 shows the overall method according to the invention.

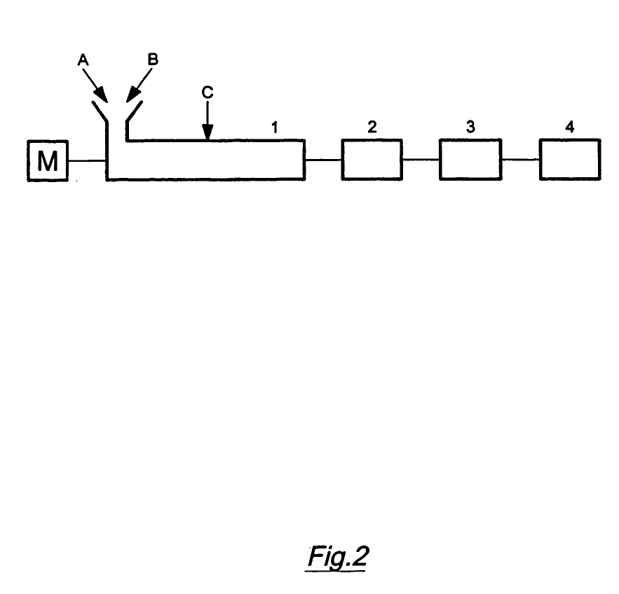

FIG. 2 shows the diagram of one possible application of the present invention, namely a depolymerization process that is regulated by a method of the present invention.

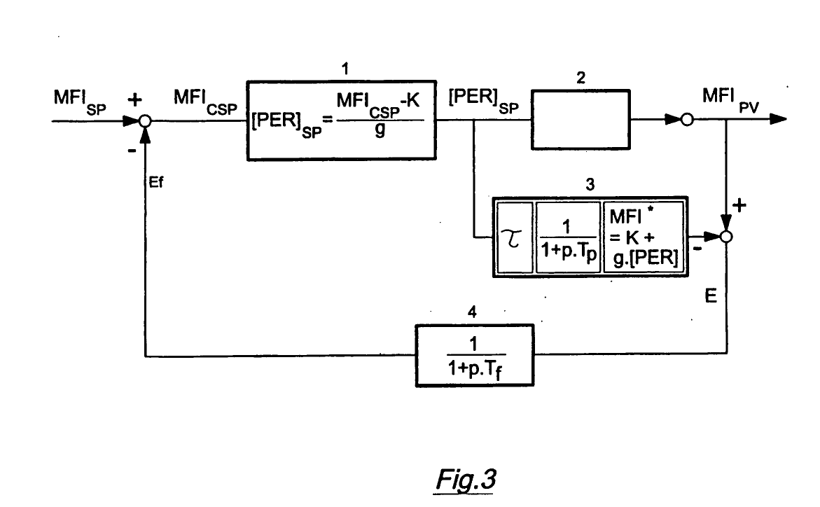

FIG. 3 shows the case of FIG. 2 using a simplified first-order model, assuming that the temperature and the melt flow index (MFI) are constant.

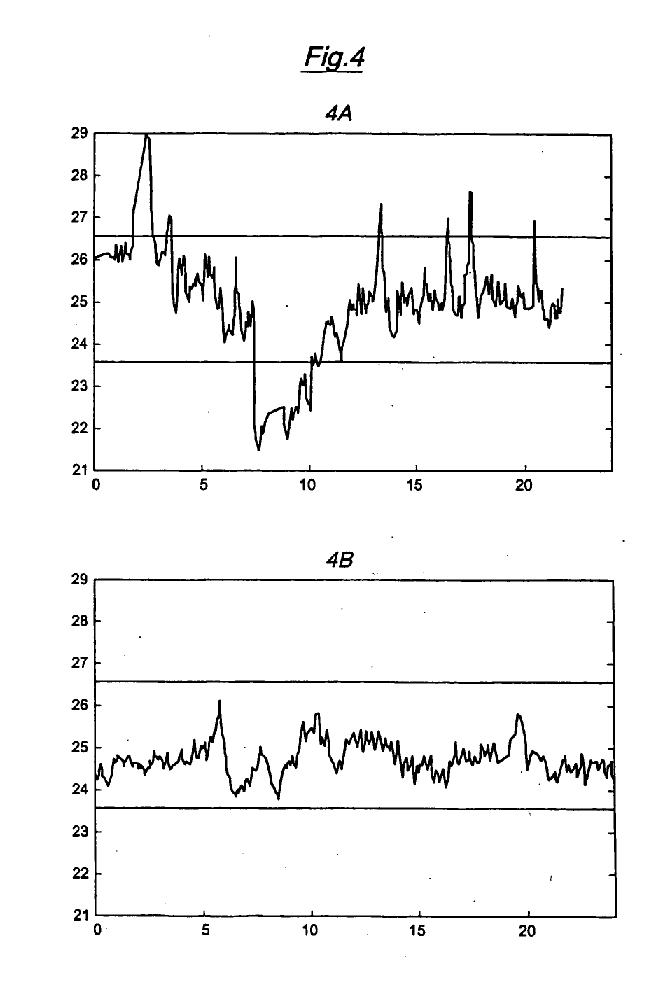

FIG. 4 shows examples of the performance obtained in the case of a PP resin.

As FIG. 1 shows, the setpoint value (SP) is introduced into the regulating system (regulator 1) based on the model generated in step (a) and using, for example, the inverse of this model.

The result of the regulation acts on the process (2) by regulating the actual value of the property (PV) and on the model (3) in order to compute the model value (MV). The actual value (PV) is measured and compared with the model value (MV) in order to determine the difference (E) therebetween. This difference is then filtered and the filtered difference (Ef) is used to adapt the setpoint (SP).

FIG. 2 is an example of how the present method is applied. The first case concerns a process used for adjusting the rheological characteristics of polypropylene (PP) resins. The initial resin (fluff A) and other additives (B) are mixed in the extruder (1) then a depolymerization agent (L) is added, before the compound is extruded and granulated. The typical duration of this first step is around 0.1 minutes. The granules are then washed (2), drained (3) and dried (4). This step typically takes 0.5 minutes. The resulting granules that represent the end product are then subjected to rheological measurements (MFI) after melting them, for example in a Göttfert-type rheometer. The time taken in this case is, for example, around 5 to 20 minutes.

If the diagram in FIG. 1 is applied to the process of FIG. 2, the diagram in FIG. 3 is obtained. In the case of said FIG. 3, the model is a simplified model of the type MFIₒᵤₜ=K+g.[PER] (as described above)—the factor taking the dynamics into account is a function of the type

$$\frac{1}{1 + p \cdot TP} ,$$

using the formalism of Laplace transforms, and also described above.

τ is the delay and the filter is produced by a function of the type

$$\frac{1}{1 + p \cdot Tp}$$

(using the Laplace formalism) in which p represents the period of the measurement and Tf the response time of the filter.

As we saw in FIG. 2, the typical delay (τ) ranges from 5 to 20 minutes or longer. The factor taking the delay into account is in this case, for example, a Smith predictor or any other appropriate method. The setpoint (MFI_{SP}) is used to determine the amount (or concentration) [PER]_{SP} of depolymerization agent needed. This concentration is then introduced into the model and the result, that is to say the model value, is compared with the actual value (MFI_{PV}) in order to determine the difference (E) between them. After filtering, the filtered difference (E_{f}) is used to adapt the setpoint (MFI_{SP}).

The concentration of depolymerization agent is varied by an amount Δ[PER]. After a delay τ, the MFIₒᵤₜ in turn starts to vary until it again stabilizes at a value MFIₒᵤₜ+ΔMFIₒᵤₜ. The various regulating parameters may then be determined as follows:

$$process gain \begin{matrix}: & g = \frac{Δ {MFI}_{out}}{Δ [ PER ]} ;\end{matrix}$$

constant of the model K=MFIₒᵤₜ−g.[PER];

the time constant of the process: Tp=time needed to reach 63% of the ΔMFIₒᵤₜ taking the delay τ into account;

the time constant relating to filtering the difference E between the measured value and the computed value is set to 1.5 min.

The following example and FIG. 4 illustrate the invention.

### EXAMPLE

A polypropylene (PP) resin with an initial MFI of around 1 g/10 min undergoes depolymerization. The depolymerization is carried out once using a conventional PID-type regulating method and once using the regulating method of the present invention based on a first-order model+delay+dynamic factor.

FIG. 4 illustrates the performance obtained with and without regulation according to the present invention (graphs 4A and 4B, respectively). In the graphs, the time expressed in hours is plotted on the x-axis and the MFI expressed in g/10 min, measured using a Göttfert apparatus, is plotted on the y-axis. The graphs also indicate the upper and lower limits of the specifications.

1. A method of regulating a property of a product resulting from a chemical transformation process, consisting:
a) in modeling the relationship between said property and characteristic quantities of the process;
b) in setting a setpoint value for said property;
c) in introducing this setpoint value into a regulating system based on the model obtained in (a) so as to apply at least one characteristic quantity, computed from this setpoint value, to the process;
d) in computing, by means of the model defined in (a), corrected by a factor that takes the delay into account, of a model value of the product property corresponding to the quantity/characteristic quantities defined by the regulating system;
e) in continuously measuring the actual value of the product property;
f) in determining the difference between this actual value and the model value of the product property; and
g) in using this difference, after filtering, to adapt the setpoint value so as to align the actual value and its model value.

2. The regulating method as claimed in claim 1, in which the model value corresponding to the characteristic quantity/quantities is computed using the model defined in (a) corrected by the factor that takes the delay into account and by a factor that takes the dynamics of the process into account.

3. The regulating method as claimed in either of claims 1 and 2, applied to a process for transforming a polymer in an extruder such as, for example, a depolymerization process using one or more polymers and one or more depolymerization agents as reactants.

4. The method as claimed in any one of claims 1 to 3, in which the actual value of the product property is measured on a specimen of the end product.

5. The regulating method as claimed in any one of the preceding claims, in which the filter used is a low-pass-type filter.

6. The regulating method as claimed in any one of claims 1 to 5, in which the model is based on an equation of the type:
$$\begin{matrix}MV = a + bIV + {\sum }_{i = 1}^{n} {\sum }_{j = 1}^{p} {{c}_{ij} [ {R}_{j} ]}^{i} + {\sum }_{i = 1}^{n} {\sum }_{j = 1}^{p} {{d}_{ij} [ Tj ]}^{i} + \\ {\sum }_{i = 1}^{n} {\sum }_{j = 1}^{p} {{e}_{ij} [ {P}_{j} ]}^{i} + {\sum }_{i = 1}^{n} {\sum }_{j = 1}^{p} {{f}_{ij} [ Fj ]}^{i}\end{matrix}$$
where:
MV represents the model value or estimated value;
IV represents the initial value of the property;
[Rⱼ] represents the concentrations of the reactants;
[Tⱼ] represents characteristic temperatures of the process;
[Pⱼ] represents characteristic pressures of the process;
[Fⱼ] represents the flow rates of the reactants;
a, b, cᵢⱼ, dᵢⱼ, eᵢⱼ and fᵢⱼ are constants;
i and j are natural integers greater than or equal to 1.

7. The regulating method as claimed in any one of claims 1 to 5, in which the model is based on an equation of the type:
$$\begin{matrix}log MV = {a}^{′} + {b}^{′} log IV + {\sum }_{i = 1}^{n} {\sum }_{j = 1}^{p} {{c}_{ij}^{′} [ {R}_{j} ]}^{i} + {\sum }_{i = 1}^{n} {\sum }_{j = 1}^{p} {{d}_{ij}^{′} [ Tj ]}^{i} + \\ {\sum }_{i = 1}^{n} {\sum }_{j = 1}^{p} {{e}_{ij}^{′} [ {P}_{j} ]}^{i} + {\sum }_{i = 1}^{n} {\sum }_{j = 1}^{p} {{f}_{ij}^{′} [ Fj ]}^{i}\end{matrix}$$
where:
MV represents the model value or estimated value;
IV represents the initial value of the property;
[Rⱼ] represents the concentrations of the reactants;
[Tⱼ] represents characteristic temperatures of the process;
[Pⱼ] represents characteristic pressures of the process;
[Fⱼ] represents the flow rates of the reactants;
a′, b′, c′ᵢⱼ, d′ᵢⱼ, e′ᵢⱼ and f′ᵢⱼ are constants;
i and j are natural integers greater than or equal to 1.

8. The regulating method as claimed in any one of claims 1 to 7, in which the factor taking the delay into account is obtained using a shift register.

9. The regulating method as claimed in any one of claims 1 to 8, in which the factor taking the dynamics of the process into account is represented by an LAG-type function or a low-pass filter.

10. A device for regulating a property of a product resulting from a chemical transformation process, comprising:
at least one unit for regulating at least one characteristic quantity on the basis of a setpoint value of the property to be regulated;
at least one computing unit for determining a model value of the property to be regulated on the basis of the values of the characteristic quantity/quantities defined by the regulator;
means for continuously measuring the actual value of the product property;
means for determining the difference between the actual value and the model value of the property and for filtering this difference; and
means for adapting the setpoint value so as to reduce this difference.

11. The device as claimed in claim 10, characterized in that it uses a method as claimed in any one of claims 1 to 9.

12. The device as claimed in claim 10, in which the computing unit uses a model with proportional, integral and/or differential terms, corrected by a factor taking the delay into account and possibly by a factor taking the dynamics of the process into account.

13. The device as claimed in claim 12, in which the regulator uses the inverse of the model generated for the computing unit.

14. The device as claimed in any one of claims 10 to 13, in which the characteristic quantities of the chemical transformation process are chosen from among the concentrations and flow rates of the reactants, the residence times, the pressures and/or temperatures of one or more of the steps of the process.

15. A chemical transformation process using a regulating device according to any one of claims 10 to 14 or employing a regulating method as claimed in any one of claims 1 to 9 for monitoring and regulating a property of a product resulting from a chemical transformation process.

16. The process as claimed in claim 15, characterized in that the chemical transformation is a depolymerization reaction using one or more polymers and one or more depolymerization agents as reactants.

17. The process as claimed in claim 16, characterized in that at least one of the polymers is a polyolefin.

18. The process as claimed in claim 17, characterized in that the polyolefin is polypropylene.

19. The process as claimed in any one of claims 16 to 18, characterized in that at least one depolymerization agent is chosen from among oxygen, oxygen-rich compounds, peroxides, persulfates and diazo compounds.

20. The process as claimed in any one of claims 16 to 19, characterized in that the product property to be monitored and regulated is the melt flow index (MFI).

21. The process as claimed in claim 20, characterized in that the melt flow index (MFI) is determined using a rheometer, an IR spectrometer, an NIR spectrometer, an NMR spectrometer and/or an ultrasonic analyzer.

22. The process as claimed in any one of claims 15 to 21, characterized in that the actual value of the product property is determined directly in line.

23. The process as claimed in claim 22, characterized in that the actual value of the product property is determined on a specimen of the end product.

24. The process as claimed in any one of claims 16 to 23, applied to the regulation of the melt flow index (MFI) of a polymer, in which the model value of the MFI may be computed on the basis of the model:
MKIₒᵤₜ=A+B.MFIᵢₙ+C.[per]+D.T
where:
MFIₒᵤₜ represents the estimated melt flow index of the depolymerization product;
MFIᵢₙ represents the melt flow index of the polymer reactant;
A, B, C and D represent constants;
[PER] represents the concentration of depolymerization agent; and
T represents the temperature at which the depolymerization reaction takes place.

25. The process as claimed in any one of claims 16 to 23, applied to the regulation of the melt flow index (MFI) of a polymer, in which the model value of the MFI is computed on the basis of the model:
logMFIₒᵤₜ=A′+B′.logMFIᵢₙ+C′.[PER]+D′T
where:
MFIₒᵤₜ represents the estimated melt flow index of the depolymerization product;
MFIᵢₙ represents the melt flow index of the polymer reactant;
A′, B′, C′ and D′ represent constants;
[PER] represents the concentration of depolymerization agent; and
T represents the temperature at which the depolymerization reaction takes place.

26. The process as claimed in any one of claims 16 to 23, applied to the regulation of the melt flow index (MFI) of a polymer, in which the model value of the MFI is computed on the basis of the model:
logMFI_{OUT}=A″+B″.logMFIᵢₙ+C₁″.[PER]²D″.T
where:
MFIₒᵤₜ represents the estimated melt flow index of the depolymerization product;
MFIᵢₙ represents the melt flow index of the polymer reactant;
A″, B″, C₁″ C₂ and D″ represent constants;
[PER] represents the concentration of depolymerization agent; and
T represents the temperature at which the depolymerization reaction takes place.

27. The process as claimed in any one of claims 24 to 26, in which the delay factor is obtained using a shift register.

28. The process as claimed in any one of claims 24 to 26, in which the factor taking the dynamics of the process into account is represented by a first-order low-pass filter.

29. The process as claimed in any one of claims 24 to 28, in which the melt flow index is regulated by adjusting the concentration of depolymerization agent or by adjusting the flow rate of said depolymerization agent.

30. The process as claimed in any one of claims 24 to 29, characterized in that the melt flow index of the polymer reactant (MFIᵢₙ) and/or the temperature (T) are assumed to be constant.
